(19) United States
(12) Patent Application Publication
(10) Pub. No.: US 2025/0384776 A1
(43) Pub. Date: Dec. 18, 2025

(54) MANAGING AIRCRAFT INFORMATION

(71) Applicant: SITA Information Networking Computing Canada Inc., Montreal (CA)

(72) Inventors: Olivier MAYO, Montreal (CA); Sergei RYBAKOV, Montreal (CA); Elham BOOZARJOMEHRI, Montreal (CA); Kemal AHMED, Hayes (GB); Pere FLO, Barcelona (ES)

(21) Appl. No.: 19/303,583

(22) Filed: Aug. 19, 2025

Related U.S. Application Data
(63) Continuation of application No. PCT/CA2024/050258, filed on Mar. 1, 2024.

(30) Foreign Application Priority Data
Mar. 2, 2023 (EP) 23382192.5

(51) Int. Cl. G08G 5/26; G08G 5/72

(52) U.S. Cl. CPC G08G 5/26; G08G 5/727

(57) ABSTRACT

A method of managing aircraft information is provided. The method comprises receiving scheduling information, the scheduling information comprising flight and turnaround information relating to a plurality of aircraft; extracting the flight and turnaround information for each of the plurality of aircraft from the scheduling information; assigning the extracted flight and turnaround information for each of the plurality of aircraft to a channel, wherein each channel corresponds to one of the plurality of aircraft; and providing access to the channels to a user. A corresponding computer system and non-transitory memory are also provided.

### CROSS-REFERENCE TO RELATED APPLICATIONS

This application is a continuation of International Application No. PCT/CA2024/050258, filed on Mar. 1, 2024, and entitled “MANAGING AIRCRAFT INFORMATION,” which claims the benefit of, and priority to, European Patent Application 23382192.5, filed on Mar. 2, 2023, and entitled “MANAGING AIRCRAFT INFORMATION,” the disclosures of which are hereby incorporated by reference in their entireties as if set forth herein.

### TECHNICAL FIELD

The present invention relates to a method of managing aircraft information. A corresponding computer system and non-transitory memory are provided.

### BACKGROUND

Modern air travel relies on communication between a number of different parties, such as between aircraft, airline operators, and airport controllers. As the airline industry has evolved, a number of disparate communication systems have been developed to provide communication between particular parts of the flight ecosystem. For example, the ACARS system provides messaging capability between aircraft and ground stations.

However, communication for airlines can be extremely challenging given the considerable number of people involved with a flight (e.g., pilots, airline operators, airport controllers, etc.) and heterogeneous means of communication (ACARS, SMS, telephone, walkie-talkie, IP messaging, email, in person, etc.), while poor communication unfortunately results in longer turnaround times that are extremely costly to airlines.

It is desirable to provide a means of integrating different forms of communication so that a user can communicate with all relevant parties through a single interface, as well as access relevant flight and turnaround information in a single location.

### SUMMARY OF INVENTION

The invention is defined by the independent claims. Preferred features are set out in the dependent claims.

According to a first aspect of the invention, a method of managing aircraft information is provided. The method comprises receiving scheduling information, the scheduling information comprising flight and turnaround information relating to a plurality of aircraft; extracting the flight and turnaround information for each of the plurality of aircraft from the scheduling information; assigning the extracted flight and turnaround information for each of the plurality of aircraft to a channel, wherein each channel corresponds to one of the plurality of aircraft; and providing access to the channels to a user.

Optionally, the method further comprises determining, for each aircraft based on the extracted flight and turnaround information for that aircraft, one or more turnaround tasks to be completed; monitoring the progress of the one or more turnaround tasks; and presenting a current status of the one or more turnaround tasks.

Optionally, determining, for each aircraft based on the extracted flight and turnaround information for that aircraft, one or more turnaround tasks to be completed comprises: obtaining an aircraft identification from the extracted flight and turnaround information; and querying a database for turnaround tasks corresponding to the aircraft identification.

Optionally, the method further comprises receiving a plurality of communications; extracting an aircraft identification from each of the plurality of communications, the aircraft identification indicating an aircraft the message is associated with; and assigning each of the plurality of communications to the channel corresponding to the aircraft associated with each message.

Optionally, the plurality of communications comprise communications of a first type and communications of a second type; and the communications of the first type and the communications of the second type are presented in the channel in an integrated manner.

Optionally, the communications of a first type are ACARS messages, and receiving a plurality of communications comprises: receiving one or more ACARS messages extracting an aircraft identification from each of the one or more the ACARS messages, the aircraft identification identifying an aircraft from which the corresponding ACARS message originated; converting each of the one or more ACARS messages to a message of the second type; and assigning each of the one or more converted ACARS messages to a channel corresponding to the aircraft from which the message originated.

Optionally, each channel corresponding to an aircraft is not capable of displaying ACARS messages but is capable of displaying messages of the second type.

Optionally, the communications of the second type are not ACARS messages.

Optionally, the communications of the second type are SMS messages, emails, or IP messages.

Optionally, the one or more ACARS messages comprise a notification of a status of the originating aircraft or a component of the originating aircraft.

Optionally, determining, for each aircraft based on the extracted flight and turnaround information for that aircraft, one or more status events; monitoring the progress of the one or more status events based on the one or more ACARS messages; and presenting a current status of the one or more status events.

Optionally, determining, for each aircraft based on the extracted flight and turnaround information for that aircraft, one or more status events comprises obtaining an aircraft identification from the extracted flight and turnaround information; and querying a database for status events corresponding to the aircraft identification.

Optionally, the aircraft identification uniquely identifies an aircraft.

Optionally, the aircraft identification comprises one or more of an aircraft registration code, an aircraft model, and a flight number.

Optionally, providing access to the channel to a user comprises receiving a channel access request from a user; receiving a permission status of the user; and allowing access to the channel in accordance with the permission status.

Optionally, if the permission status of the user is indicative of a full permission, allowing access in accordance with the permission status comprises allowing the user to view and send communications of a first type and a second type.

Optionally, if the permission status of the user is indicative of a partial permission, allowing access in accordance with the permission status comprises allowing the user to view but not send communications of the first type, and view and send communications of the second type.

Optionally, if the permission status of the user is indicative of no permission, allowing access in accordance with the permission status comprises not allowing the user to view or send communications of the first type, but allowing the user to view and send communications of the second type.

Optionally, the communications of a first type are ACARS messages, and the method further comprises receiving, in a channel and from a user with full permission, a message to be sent to the aircraft corresponding to that channel; converting the message into an ACARS message; and sending the ACARS message to the aircraft.

According to a second aspect, a computer system configured to perform the method of the first aspect is provided.

According to a third aspect, a non-transitory memory having stored thereon instructions that, when executed on the computer system of the second aspect, cause the computer system to perform the method of the first aspect is provided.

### BRIEF DESCRIPTION OF THE DRAWINGS

Exemplary only implementations of the invention are described with reference to the following figures:

FIG. 1 illustrates a method of managing aircraft information;

FIG. 2 illustrates a channel of an aircraft information management application according to aspects of the invention; and

FIG. 3 illustrates another channel of an aircraft information management application according to aspects of the invention.

### DETAILED DESCRIPTION OF THE INVENTION

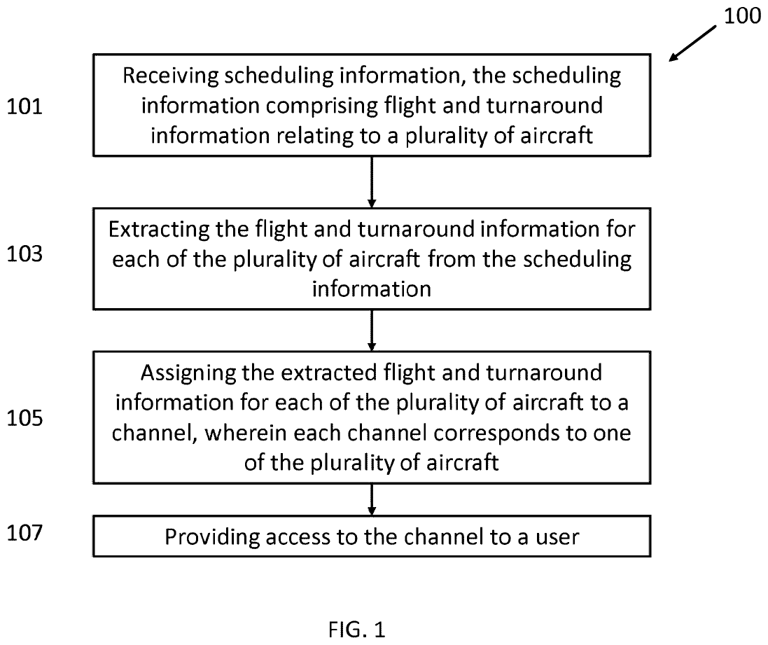

FIG. 1 illustrates a method 100 for managing aircraft information. The method begins at step 101 and comprises receiving scheduling information. The scheduling information comprises flight and turnaround information relating to a plurality of aircraft. For example, this may be all of the aircraft operated by a particular airline. The flight and turnaround information may include information such as aircraft identification codes, flight numbers, flight destinations, flight origins, flight times, aircraft stands, the amount of fuel on board, etc.

The flight and turnaround information for each of the plurality of aircraft is extracted from the scheduling information at step 103 and assigned to a channel at step 105. Each channel corresponds to a different aircraft, and conversely each aircraft has its own dedicated channel. That is, there is a one-to-one correspondence between the number of aircraft and the number of channels.

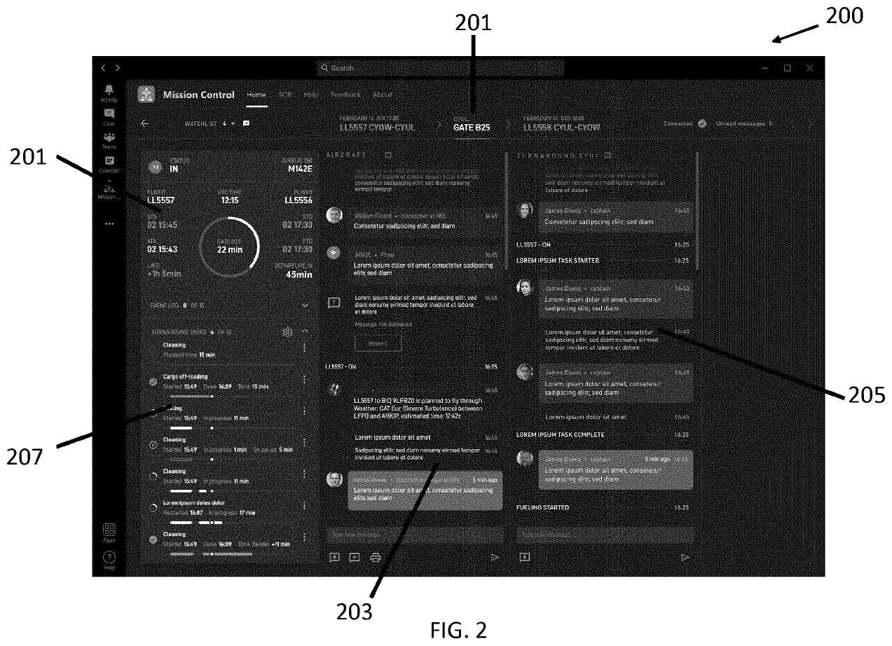

A channel, as defined herein, is a section within an application for managing aircraft information. An exemplary channel 200 is illustrated in FIG. 2. Suitable applications include web applications, computer programs, etc. In the illustrated embodiments, the application is implemented through Microsoft Teams. However, this is not limiting and it will be appreciated that any of the features discussed below can be implemented in an application implemented in another format.

At step 107, access to the channels is provided to a user. This allows the user, depending upon their permission level, to view certain information relating to the aircraft associated with a particular channel.

As noted above, FIG. 2 illustrates an exemplary view of a channel 200 within an application for managing aircraft information. Information that is accessible through channel 200 includes flight information 201 for the aircraft corresponding to the channel, communications to and from the aircraft corresponding to the channel 203, other communications relating to the aircraft corresponding to the channel 205, and turnaround tasks 207 associated with the aircraft corresponding to the channel.

It may be beneficial to monitor the progress of turnaround tasks 207 and present the progress to a user of the channel 200. This may be done by determining one or more turnaround tasks 207 to be completed for the aircraft corresponding to the channel, monitoring the progress of the one or more turnaround tasks 207, and presenting a current status of the one or more turnaround tasks 207 within the channel 200.

The turnaround tasks 207 to be monitored can be manually input by a user of the application, but it is preferred that they are automatically obtained. This may be implemented by obtaining an aircraft identification from the extracted flight and turnaround information and querying a database for turnaround tasks 207 corresponding to the aircraft identification. The turnaround tasks 207 may be set by an airline, dependent upon the aircraft model, or some combination of these and/or other factors. The turnaround tasks 207 are generally tasks that require manual input in some form to inform their progress. The application can receive messages from suitably authorised users (in a number of formats, such as SMS, IP messaging, etc.) to provide status updates for the turnaround tasks 207, such as “in progress”, “completed” or “not applicable”.

It will be appreciated that while some information may also be presented in the channel 200, such as the flight information 201 and the communications 203, 205, other information presented may be dependent upon a current status of the aircraft corresponding to the channel 200. For example, turnaround tasks 207 may not be present if the aircraft is currently in flight.

While the turnaround tasks 207 may require manual updating, some events can be monitored automatically. Additionally, it will be appreciated that flight information and turnaround information may also be updated. This may be achieved in real time via an uplink to the aircraft to enable the channel 200 to, for example, indicated an updated flight destination and/or an updated flight time may be updated in the event of a diversion or a delay. In another example, the channel 200 may also indicate a real-time indication of the fuel on board the aircraft.

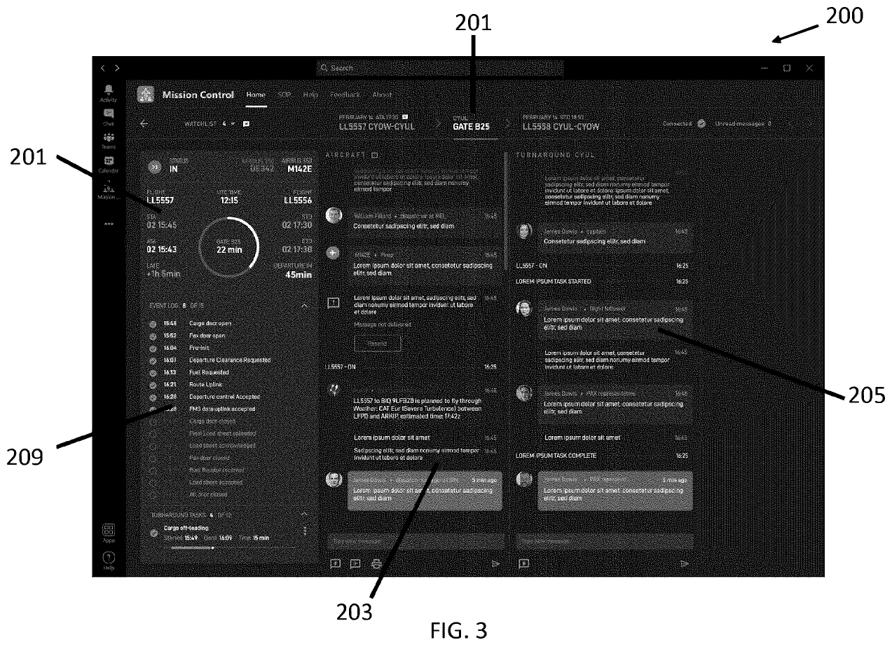

FIG. 3 illustrates another view of channel 200, which generally corresponds to the view in FIG. 2 except that status events 209 have replaced the turnaround events 207. The status events 209 correspond to events that the aircraft is configured to provide automatic updates on. For example, the avionics of the aircraft may be configured to transmit certain notifications when a particular event, such as “cargo door open” is detected. The status events 209 that can be monitored will depend upon what events the aircraft is configured to monitor.

The aircraft may notify the application of these events using ACARS (Aircraft Communications Addressing and Reporting System) messaging. Monitoring the status events 209 may be performed by determining, for each aircraft based on the extracted flight and turnaround information for that aircraft, one or more status events 209; monitoring the progress of the one or more status events 209 based on one or more ACARS messages received from an aircraft; and presenting a current status of the one or more status events 209. The status events 209 to be monitored for a particular aircraft can be determined in a similar way to the turnaround tasks 207.

ACARS messages can typically only be received by special, legacy hardware. Therefore, it is desirable for the system to be able to convert ACARS messages into another message format (e.g., IP messages) that can more easily be interpreted and/or displayed within the channel.

This also enables communications to and from the aircraft 203 to be displayed within the channel 200, alongside other, non-ACARS communications 205 relating to the aircraft. This can be done by receiving one or more ACARS messages, extracting an aircraft identification from each of the one or more the ACARS messages (the aircraft identification identifying an aircraft from which the corresponding ACARS message originated), converting each of the one or more ACARS messages to a message of the second type, and assigning each of the one or more converted ACARS messages to a channel corresponding to the aircraft from which the message originated.

Similarly, it is also desirable that a message can be sent to an aircraft from the channel 200. This requires receiving, in a channel and from a user with full permission, a message to be sent to the aircraft corresponding to that channel, converting the message, received in a format such as an IP message, into an ACARS message, and sending the ACARS message to the aircraft.

Whilst it is beneficial for some users to be able to view all of the information relating to a particular aircraft, and to send messages to the aircraft, it may be desirable to limit this access to only certain users. For other users, it may be desirable to not allow them to send messages to the aircraft but to view messages sent to and from the aircraft. Yet for other users, it may be desirable to not allow them to view or sent messages to or from the aircraft, but instead only to see other information (such as turnaround tasks 207).

To achieve this, providing access to the channel to a user may comprise receiving a channel access request from a user; receiving a permission status of the user; and allowing access to the channel in accordance with the permission status.

It may be preferably, as noted above, to have three different levels of permission: full permission, partial permission, and no permission, relating to the permission that a user has with respect to communications to and from the aircraft. In this case:
if the permission status of the user is indicative of a full permission, allowing access in accordance with the permission status comprises allowing the user to view and send communications of a first type and a second type;
if the permission status of the user is indicative of a partial permission, allowing access in accordance with the permission status comprises allowing the user to view but not send communications of the first type, and view and send communications of the second type; and
if the permission status of the user is indicative of no permission, allowing access in accordance with the permission status comprises not allowing the user to view or send communications of the first type, but allowing the user to view and send communications of the second type.

The above description relates only to exemplary embodiments and other variations or modifications are anticipated based on the teaching herein. The term aircraft includes, but is not limited to, aeroplanes, helicopters, and other airborne vehicles.

From the foregoing, it will be appreciated that the computer system may include a computing device, such as a desktop computer, a laptop computer, a tablet computer, a personal digital assistant, a mobile telephone, a smartphone, an internet enabled television, an internet enabled television receiver, an internet enabled games console or portable games device. The computer system may be configured to implement the methods described above.

It will also be appreciated that this invention finds application as a system for providing services to a customer or user which may be used by an airline agent or other transport services provider agent.

The computer system may be in communication with a server via one or more wired or wireless communication networks. The server may comprise a computer processor running one or more server processes for communicating with client devices. The server processes may comprise computer readable program instructions for carrying out the operations of the present invention. The computer readable program instructions may be source code or object code written in or in any combination of suitable programming languages including procedural programming languages such as C, object orientated programming languages such as C#, C++, Java, scripting languages, assembly languages, machine code instructions, instruction-set-architecture (ISA) instructions, and state-setting data.

The wired or wireless communication network described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

The computing system described above may comprise a Graphical User Interface.

Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a computing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as circuit board which may include a CPU, a bus, RAM, flash memory, one or more ports for operation of connected I/O apparatus such as printers, display, keypads, sensors and cameras, ROM, a communications sub-system such as a modem, and communications media.

The flowchart of FIG. 1 illustrates the operation of an example implementation of systems, methods, and computer program products according to various embodiments of the present invention. Each block in the flowchart or block diagrams may represent a module comprising one or more executable computer instructions, or a portion of an instruction, for implementing the logical function specified in the block. The order of blocks in the diagram is only intended to be illustrative of an example. In alternative implementations, the logical functions illustrated in particular blocks may occur out of the order noted in the figures. For example, two blocks shown as adjacent one another may be carried out simultaneously or, depending on the functionality, in the reverse order. Each block in the flowchart may be implemented in software, hardware or a combination of software and hardware.

1. A method of managing aircraft information comprising:
receiving scheduling information, the scheduling information comprising flight and turnaround information relating to a plurality of aircraft;
extracting the flight and turnaround information for each of the plurality of aircraft from the scheduling information;
assigning the extracted flight and turnaround information for each of the plurality of aircraft to a channel, wherein each channel corresponds to one of the plurality of aircraft; and
providing access to the channels to a user.

2. The method of claim 1, further comprising:
determining, for each aircraft based on the extracted flight and turnaround information for that aircraft, one or more turnaround tasks to be completed;
monitoring the progress of the one or more turnaround tasks; and
presenting a current status of the one or more turnaround tasks.

3. The method of claim 2, wherein determining, for each aircraft based on the extracted flight and turnaround information for that aircraft, one or more turnaround tasks to be completed comprises:
obtaining an aircraft identification from the extracted flight and turnaround information; and
querying a database for turnaround tasks corresponding to the aircraft identification.

4. The method of any of claims 1 to 3, wherein the method further comprises:
receiving a plurality of communications;
extracting an aircraft identification from each of the plurality of communications, the aircraft identification indicating an aircraft the message is associated with; and
assigning each of the plurality of communications to the channel corresponding to the aircraft associated with each message.

5. The method of claim 4, wherein the plurality of communications comprise communications of a first type and communications of a second type; and
wherein the communications of the first type and the communications of the second type are presented in the channel in an integrated manner.

6. The method of claim 5, wherein the communications of a first type are ACARS messages, and wherein receiving a plurality of communications comprises:
receiving one or more ACARS messages;
extracting an aircraft identification from each of the one or more the ACARS messages, the aircraft identification identifying an aircraft from which the corresponding ACARS message originated;
converting each of the one or more ACARS messages to a message of the second type; and
assigning each of the one or more converted ACARS messages to a channel corresponding to the aircraft from which the message originated.

7. The method of claim 6, wherein each channel corresponding to an aircraft is not capable of displaying ACARS messages but is capable of displaying messages of the second type.

8. The method of any of claims 5 to 7, wherein the communications of the second type are not ACARS messages.

9. The method of claim 8, wherein the communications of the second type are SMS messages, emails, or IP messages.

10. The method of claim 6, wherein the one or more ACARS messages comprise a notification of a status of the originating aircraft or a component of the originating aircraft.

11. The method of claim 10, wherein the method further comprises:
determining, for each aircraft based on the extracted flight and turnaround information for that aircraft, one or more status events;
monitoring the progress of the one or more status events based on the one or more ACARS messages; and
presenting a current status of the one or more status events.

12. The method of claim 11, wherein determining, for each aircraft based on the extracted flight and turnaround information for that aircraft, one or more status events comprises:
obtaining an aircraft identification from the extracted flight and turnaround information; and
querying a database for status events corresponding to the aircraft identification.

13. The method of any of claims 3 to 12, wherein the aircraft identification uniquely identifies an aircraft.

14. The method of claim 13, wherein optionally the aircraft identification comprises one or more of an aircraft registration code, an aircraft model, and a flight number.

15. The method of claim 1, wherein providing access to the channel to a user comprises:
receiving a channel access request from a user;
receiving a permission status of the user; and
allowing access to the channel in accordance with the permission status.

16. The method of claim 15, wherein if the permission status of the user is indicative of a full permission, the method further comprises allowing access in accordance with the permission status comprises allowing the user to view and send communications of a first type and a second type.

17. The method of claim 15, wherein if the permission status of the user is indicative of a partial permission, the method further comprises allowing access in accordance with the permission status comprises allowing the user to view but not send communications of the first type, and view and send communications of the second type.

18. The method of claim 15, wherein if the permission status of the user is indicative of no permission, the method further comprises allowing access in accordance with the permission status comprises not allowing the user to view or send communications of the first type, but allowing the user to view and send communications of the second type.

19. The method of claim 16, wherein the communications of a first type are ACARS messages, and wherein the method further comprises:
receiving, in a channel and from a user with full permission, a message to be sent to the aircraft corresponding to that channel;
converting the message into an ACARS message; and
sending the ACARS message to the aircraft.

20. A computer system configured to perform the method of any preceding claim.

21. A non-transitory memory having stored thereon instructions that, when executed on the computer system of claim 20, cause the computer system to perform the method of any of claims 1 to 19.
